(19) United States
(12) Patent Application Publication
(10) Pub. No.: US 2010/0025422 A1
(43) Pub. Date: Feb. 4, 2010

(54) Food Automate and Method for Automatically Supplying and Heating Food Packages

(75) Inventors: Patrik Björnvall, Skoghall (SE); Jan Erlandsson, Hammaro (SE)

Correspondence Address: Manelii Denison & Selter PLLC, 2000 M Street, 7th Floor, Washington DC, DC, 20036, US

(73) Assignee: Corner Vending Aktiebolag, Karlstad (SE)

(21) Appl. No.: 12/444,172

(22) PCT Filed: Oct. 8, 2007
(86) PCT No.: PCT/SE2007/050720

§ 371 Date: Sep. 3, 2009

(30) Foreign Application Priority Data
Oct. 6, 2006 (SE) 0602126-5

(51) Int. Cl. G07F 9/10; H05B 6/64

(52) U.S. Cl. 221/150 HC; 219/756

(57) ABSTRACT

The invention relates to a method for automatically supplying and heating individual portions stored in a chilled or frozen condition, and a food automate (10) for conducting the method, which food automate comprises a storage (5) for individual portions, having cooling or freezing capacity, a microwave oven unit (11), a vertically adjustable feed table (6) that is arranged in an upper position to close said storage for individual portions and to essentially close said microwave oven unit, a conveyor (19) that is arranged on said feed table, and a dispenser unit for dispensing prepared individual portions.

The present invention relates to a method for automafically supplying and heating individual portions stored in a chilled or frozen condition, and a food automate for conducting the method.

### PRIOR ART

Food automates/dispensers of the type mentioned in the introduction and of various automation designs are previously known from U.S. Pat. No. 3,386,550, U.S. Pat. No. 3,620,341, U.S. Pat. No. 4,125,205, U.S. Pat. No. 4,398,651, EP 480 857, EP 593 630, EP 945 835 and WO 2004/015 641. In certain automates, the package is manually extracted and positioned in an integral microwave oven, and in other automates a heated food portion is completely automatically achieved. The latter type has in common that the automates have a complex design with many moving parts. This may lead to a risk of food packages getting stuck in the automate, which may lead to interruption of the service. In addition, maintenance, charging and control of the automate will be more complicated as there are more moving parts.

### OBJECT OF THE INVENTION

It is therefore an object of the present invention to achieve a method and a food automate of the type defined in the introduction, which device solves the above mentioned problems.

### BRIEF ACCOUNT OF THE INVENTION

The object of the invention is achieved by achieving a method according to claim 1 and by achieving a food automate according to claim 7.

Preferred embodiments of the invention have been given the features defined in the dependent claims.

Accordingly, the present invention solves the above mentioned problem by the food automate having a single feed table that is vertically adjustable and that is arranged by an integral conveyor to close the portions storage, i.e. the refrigerator or the freezer holding the portion packages, and to feed the chosen portion package to a microwave unit and a dispenser unit. Thereby, the conveyor does not need more than one hydraulic cylinder and one motor, considerably reducing the moving parts of the food automate, and, as is clear from the described method, decreasing the time of throughput for an ordered or chosen portion package.

### BRIEF DESCRIPTION OF THE DRAWINGS

In the following, the invention is described in greater detail with reference to the accompanying drawings that show a preferred embodiment.

FIG. 1 shows a front view, i.e. the dispensing side of a food automate according to the invention,

FIG. 2 shows a view in perspective of the food automate in FIG. 1, in an extracted position,

FIG. 3 shows a partial side view over the food automate in the extracted position,

FIG. 4 shows a view in perspective over a feed table with a lifting device, in the food automate,

FIGS. 5a-5i show, in partial side views, the mode of operation of the food automate, wherein the left food automate unit as seen in FIG. 1 is shown and the right unit has been omitted for sake of clarity,

FIG. 6 shows a side view of a modified storage unit according to the invention,

FIG. 7 shows a view from above of FIG. 6,

FIG. 8 shows the encircled part in FIG. 6,

FIG. 9 shows the encircled part in FIG. 10, and

FIGS. 10-14 show a stepwise action according to the modified feed system of the shown storage.

### DESCRIPTION OF EMBODIMENT EXAMPLES

In the embodiments shown in the figures, similar details have, for the sake of simplicity, been given the same reference number.

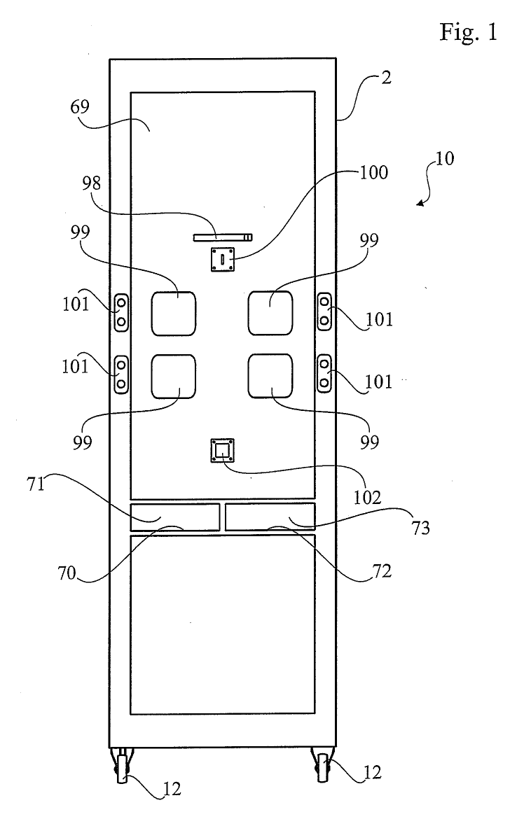

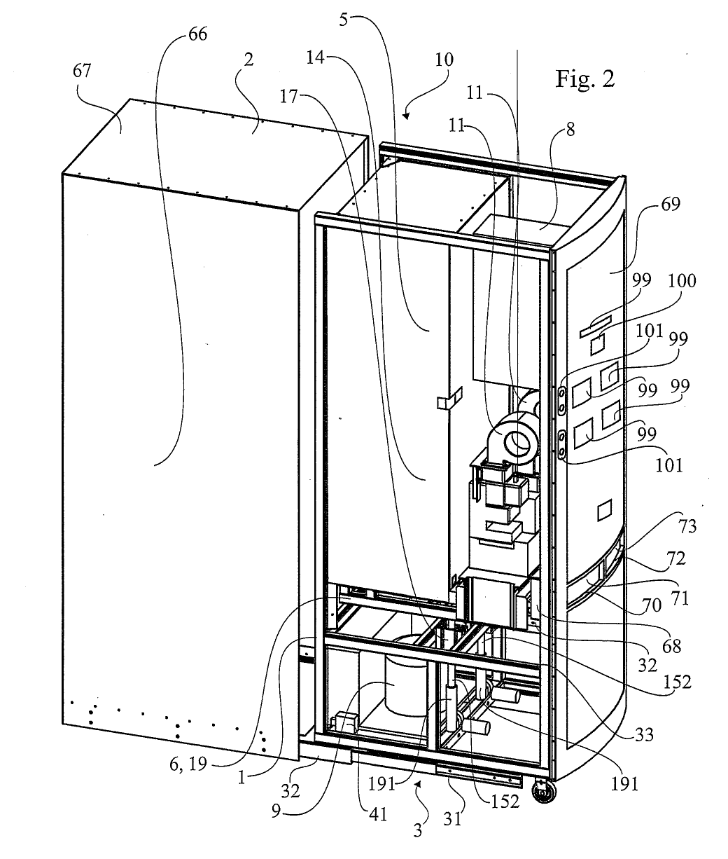

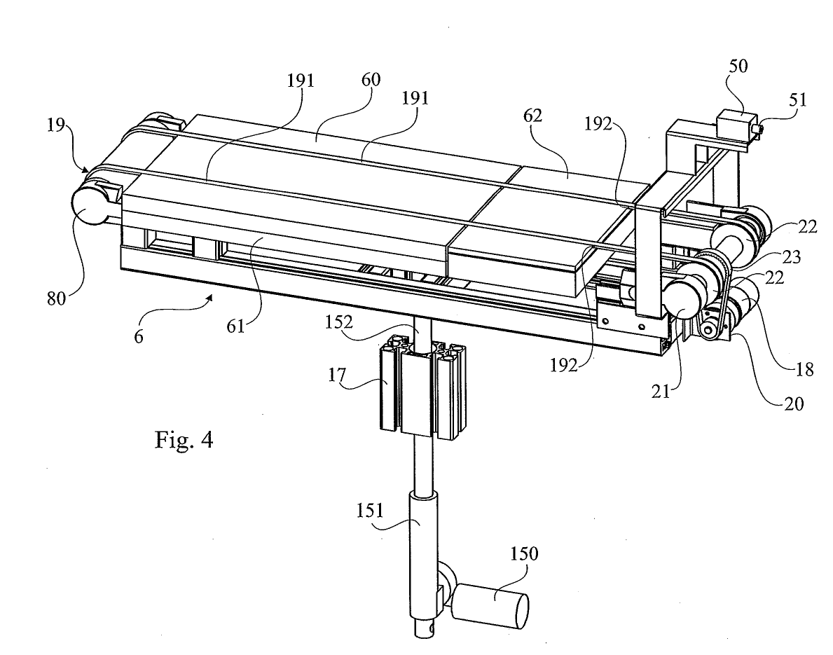

FIG. 1-4 show a food automate 10, preferably for ordering chilled or frozen portion packages 40 that are stored in a storage unit 5 and that by manual ordering are delivered in a condition as being heated by a microwave unit 11 arranged in the food automate 10.

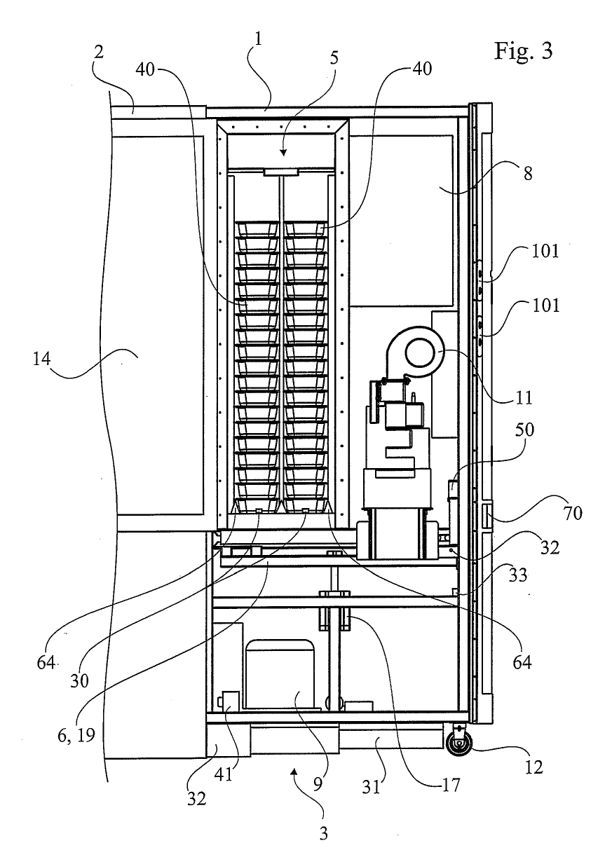

The food automate 10 comprises a frame 1, a storage unit 5 having cooling or freezing capacity for the storing of the portion packages 40, a conveyor 19 in the form of pair wise running loops or belts 191, a feed table 6 comprising a base plate 61 having an insulated plate 60 and a microwave oven bottom 62, the insulated plate 60 and the microwave oven bottom 62 being provided with longitudinal grooves 192 in which the belts 191 of the conveyor run, microwave oven units 11 and dispenser units 68 having two dispenser openings 70, 72 with dispenser covers 71 and 73, respectively arranged in the front or short side wall 69 of the automate. The feed table 6 and conveyor 19 unit can be in common for several side by side arranged piles of portion packages 40 in the storage unit 5, such as the four piles of portion packages 40 in the shown embodiment, of which only the two nearest piles in one ordering line are visible in FIG. 3.

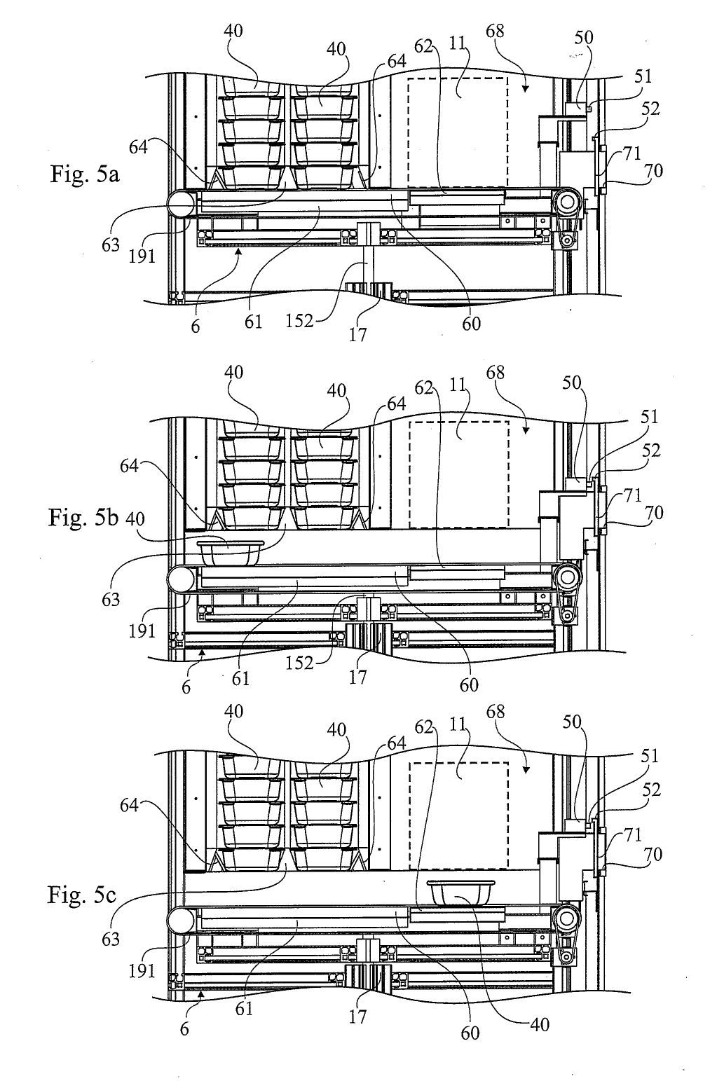

Besides the short side wall 69 the food automate 10 has a casing 2 with an opposed short side wall, an upper side 67, two long sides 66 and a bottom. The frame 1 is provided with rollers 12 and it is attached to the casing 2, together with the short side wall 69, by telescopic arms 3 arranged at the bottom of either side, the outer arms 31 being attached to the frame 1 and the inner arms 32 being attached to the casing 2. Thereby, the frame 1 with the short side wall 69 can be pulled out from the housing in order for the storage unit 5 to be charged with new portion packages 40 and for maintenance. In the extracted position, a micro switch 41 will, for safety reasons, automatically disconnect the power to the food automate 10, making it currentless. On either side of the food automate a door 14 is hinged to the frame 1, in order to give access to the storage unit 5 from either side in connection with the charging. A display unit 98 is arranged on the short side wall 69, providing the price and other information about the chosen item. There are also display units 99 that each display the contents of a pile of portion packages 40 in the storage unit 5. There is also a payment module 100 that may be formed from a slot and/or a card reader for payment of the ordered product. A keypad 101 is arranged for each pile of the storage unit 5 adjacent each respective display 99. Each keypad 101 has a, preferably red, button for hot food and a, preferably blue, button for cold food. If the red button is pressed, the food automate 10 will follow all sequences according to FIG. 5a—below. If the blue button is pressed, the portion package 40 will by-pass the microwave oven unit 11 and will instead be fed directly to the dispenser unit 68, i.e. the sequences shown in FIGS. 5c-e are omitted. At the bottom there is an opening 102 for any change and/or receipt.

The storage unit 5 having cooling or freezing capacity is divided in four sections that are delimited in relation to each other by fixed bars 56, each section being arranged to receive portion packages 40 of preferably different contents. By this delimitation between the sections, the cooling or freezing medium can reach all parts of the interior of the storage unit 5 and thereby reach all portion packages present therein. A bottom plate 60 is fixed to the base plate 61 on the feed table 6. Solenoids 30 are arranged at the lower end of the storage unit 5 in order to sense that a portion package is in position to be dispensed and flaps 64 are arranged at the lower end in order in the open position to feed a chosen portion package onto the feed table 6 and in the closed position to retain the portion packages in the piles.

The microwave oven bottom 62 of the microwave oven unit 11 is arranged, when the feed table is in the upper position, to close the heating room of the microwave unit 11 at its bottom. Upper and lower position indicators 32 and 33, respectively, are arranged to sense the end positions of the feed table 6. The chosen portion package 40 is dropped from the storage 5 onto the feed table 6 with the conveyor 19, where after the chosen portion package is transported to a position on the feed table 6 where it is fed into the microwave oven unit 11 by raising of the feed table 6 by activation of a motor 16 such that the hydraulic cylinder 151 ejects the piston 152. It is not necessary, as should be the case at the storage unit 5, to close the microwave oven unit 11 essentially sealingly by the feed table 19, but it should at least be essentially closed. The chosen portion unit 40 is positioned on the conveyor 19 at the storage unit 5 output, in such a position that it ends up at an intended position below the microwave oven unit. For a particular microwave unit it may be possible to exclude the microwave oven bottom from the feed table, for example by making the conveyor belts 191 wide enough to essentially cover the opening at the bottom of the microwave oven unit.

The reference numeral 9 denotes a compressor and the reference numeral 16 denotes motors for the hydraulic linear units that each consist of the cylinder 151 and the piston 152. A fixed guide 17 is attached to the frame 1 and fixates the cylinder 151 in order to achieve accurate guiding of the piston 152 and thereby the feed table 6. A box 8 is arranged for the control electronics for controlling the units of the food automate.

A solenoid 50 with a pin 51 that can be ejected and retracted is arranged above the dispenser openings 70, 72 in order to open the dispenser cover via which the chosen portion package 40 is to be fed out. The dispenser openings 70 (see FIGS. 5a-i) are at the respective upper edges thereof provided with a bent or attached flange 52 that is directed backwards. When, as will be described in greater detail below, the feed table 6 is brought upwards with an ordered portion package that is positioned in the dispenser unit 68, the solenoid 50 is activated such that the pin 51 ejects and engages the flange 52, thereby bringing up the cover in order to liberate one of the openings 70 or 72.

The feed table 6 has a base plate 61 and an insulated bottom 60 that is fixed to the base plate 61. A freely journalled roll 80 is attached to the end of the feed table 6 that faces inwards in the housing 2, and a freely journalled belt shaft 21 is arranged at the end of the feed table 6 that faces the wall 69. The conveyor belts 191 run in the grooves 192 in the base plate 60 of the feed table 6 and over belt rolls 22 attached to the belt shaft 21. Driving motors 18 are arranged at either side of the belt shaft 21. Each motor 18 drives a synchronous drive belt 20 that runs over a cog wheel 23 that is fixed to the belt shaft 21.

FIG. 5a—show an possible operating sequence of the food automate 10 according to the invention, in which the left feed table 6 is shown, as seen from the front, with its associated functions and the right feed table has been omitted for the sake of clarity. Naturally, the order of the sequence is the same on both sides of the food automate 10.

FIG. 5a shows the staring position before a product in the form of a portion package 40 is ordered from the, as seen from the front 69, right and front one of the four piles in the storage unit 5. In this position, the feed table 6 is in its upper position and the base plate 61 with its insulated bottom 60 forms the bottom of the storage unit 5 and closes it from beneath such that none or only minor downdraught may result.

After a product has been ordered by aid of the display units 98, 99, the payment module 100 and the keypads 101, the feed table 6 is lowered to the position shown in FIG. 5b. Thereby, the flap 64 is opened such that the portion package 40 will slide down to the feed table 6. With the purpose of ensuring release of the portion package from the edge of the flap 64, the conveyor belt 191 feeds backwards in this connection. Hence, the movement backwards of the conveyor belt 191, as seen in the transport direction, facilitates for the portion package 40 to fall down completely onto the feed table instead of its front end getting stuck at the flap 64 at the lower end of the piles. FIG. 5b shows that the flap 64 has returned to its position in order retain the rest of the portion packages in the pile.

In FIG. 5c, the conveyor belts 191 have been fed forward to a position in which the portion package 40 is below the diagrammatically shown microwave oven unit 11.

In FIG. 5d, the feed table 6 has returned to its upper position and the chosen portion package 40 is now inside the microwave oven unit that is sealed at the bottom by the microwave oven bottom 62 on the feed table 6. In this position the contents of the portion package 40 is heated for a predetermined time in order to achieve the intended temperature. In this upper position, the feed table 6 is arranged sealingly to close the storage unit by its insulated bottom 60, in order to prevent downdraught.

In FIG. 5e, the feed table 6 has returned to the lower position to enable the portion package 40 to be fed forward In FIG. 5f, the portion package 40 has been fed to the dispenser unit 68.

FIG. 5f shows that the feed table 6 has been brought up to the upper position in which the insulated bottom 60 closes the storage unit 5 and the portion package 40 has been brought up to a position right in front of the dispenser opening 70. The cover 71 has been lifted by the pin 51 of the solenoid 50 having been ejected and having engaged a flange 52 at the upper edge of the cover, and by the feed table 6 having been brought up to the upper position said pin 51 has pulled up the cover 71, whereby the opening 70 opens up in order to dispense the portion package 40 by the conveyor belt feeding the latter a predetermined distance.

FIG. 5h shows the portion package 40 in a dispensing position in which it has been fed forward an additional predetermined distance and partly projects from the opening 70 in order to be manually taken by the orderer. Not until the orderer has removed the portion package 40 from the opening 70 a new order can be performed at this side of the food automate 10. This ca be achieved by a not shown sensor signalling that the portion package has been removed. It should be noted that the feed table 6 is held in this position as long as the portion package 40 is in the opening 70, in order to prevent unnecessary downdraught from the storage unit 5.

Finally, FIG. 5i shows that the orderer has acted the package from the opening 70 and that the feed table 6 has been brought to the lower position together with the cover 71, after which the pin 51 of the solenoid releases the cover 71 in this closed position. Thereafter, the feed table 6 is brought to the position shown in FIG. 5a, in which the storage unit 5 is closed by the insulated bottom 60 and is in position to receive a new order.

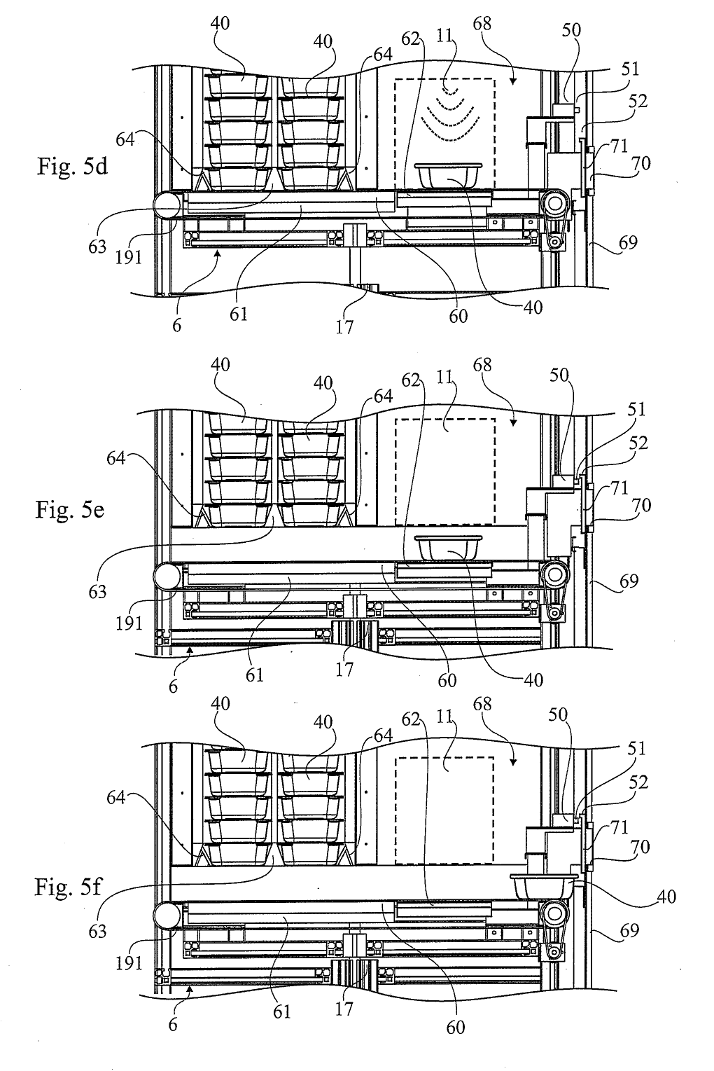

FIG. 6 shows a sideview of a food storage compartment 5 of a modified design according to the invention. The feed table 6, its transfer band 19 and its display cement mechanism 151, 152 are basically the same as described above and will therefore not be commented upon in detail. In FIG. 6 it is shown that the storage 5 presents two rows A, B for food packages 40. Upwardly, vertically extending pair-wise support structures 520, 520′ (Also a further pair 520″, 521″ for row B) are arranged, attached to a lowermost frame unit 540, to form the first row A, i.e. between an outermost support structure 520 and a support structure 520′ (hidden behind 520″) positioned in the middle of the frame unit 540. In the following merely the structure regarding the row A, will be explained since the design for the other row B is the same. To control each row, e.g. row A, a plurality of sets of pivotal arms 501, 502, in a pair-wise manner are arranged to be pivotable from a substantially horizontal position to a lower most position of about 45°. The number of sets of pairs of pivotal arms determine the amount of food packages 40 that may be contained in a row. To lower a food package from a first level 500+1 to the next level 500 in the row A, there exists a first pair 501, 501′ to lower the package half the way and a second pair 502, 502′ to lower it the remaining half. Accordingly if there are n pivotable second arm pairs 502, 502′ there are also the same amount of first pivotal arms 501, 501′ implying that n food packages may be stored in the row. If the lowermost level is defined as 500 then the uppermost level will be 500+n. In FIG. 6 there are shown three food packages 40-40″, resting on the set of second pairs 152, 152′, wherein the lowermost food package 40″ rests on the pair of lowermost horizontally positioned pivotal arms 502, 502′ positioned in the bottom level, i.e. plane 500. The other pairs of pivotal arms 501, 501′ will be positioned angled downwardly and will then not be supporting any food packages.

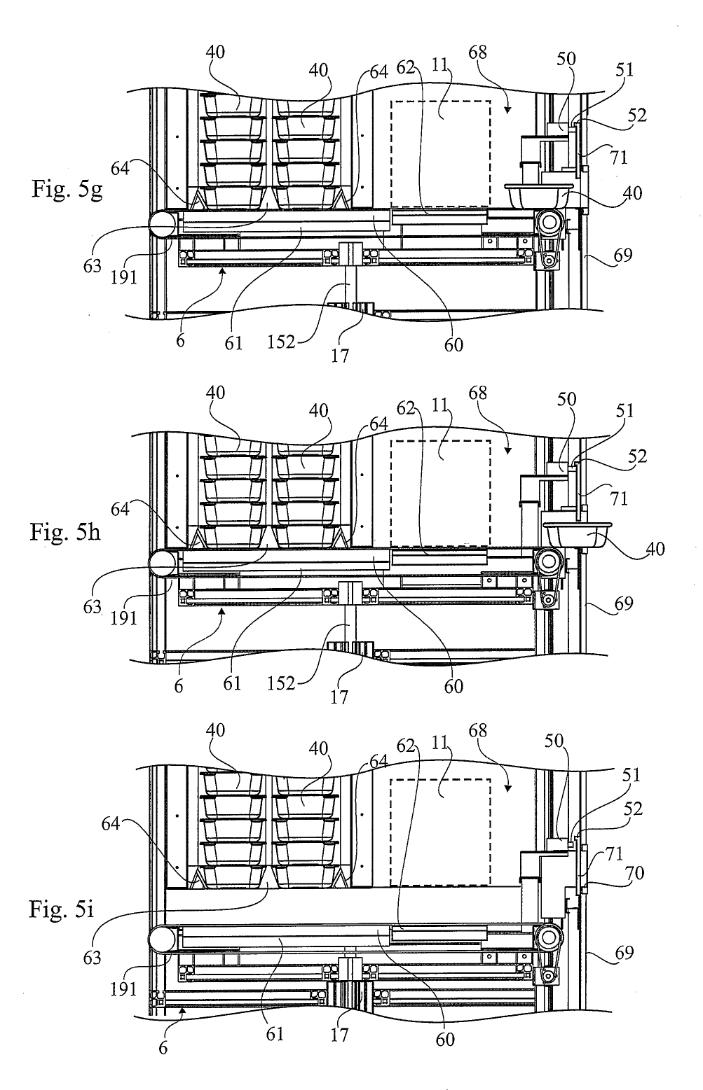

In FIG. 7 it is clearly shown that next to each fixed support structure 520 there is also arranged a slidable support plate 521, (and accordingly a corresponding slidable support plate 521′ next to the fixed support 521). The longitudinal extension of the slidable guide plate 521 is the same as for the fixed support structure 520. Further it is shown that each pivotal arm e.g. 501, is formed to have an innermost rodlike portion 501A and at the outer end thereof a holding portion 501B of substantial width (e.g. in the range of 30-100 mm) to safely support a package. Every second pivotable arm 502 is pivotally fixed by means of a pin 503, in the fixed support structure 520, on one side of the joint structure 520, 521, whereas each first pivotal arm 501 fixedly attached by means of a pin 504, 504′ to the slidable support plate 521. Accordingly the pivotal points 504 of the first pivotal arms 501 (on one side of the total structure) will follow the movement of the sliding support plate 521, whereas the pivotal points 503 of the other pivotal arms 502 will always be fixedly positioned in relation to the frame unit 504. A pair of guide pins 523 are fixed to the slidable support plate 521 and a pair of slits 522 are provided in the fixed support structure 520, to guide the movement of the slidable support plate 520 in the vertical direction only, by means of having the pin 523 sliding in the slit 522. Each slideable support plate 521, 521′, 521″ may be locket by a lock pin 580 (see FIG. 6) to fix it against downward movement.

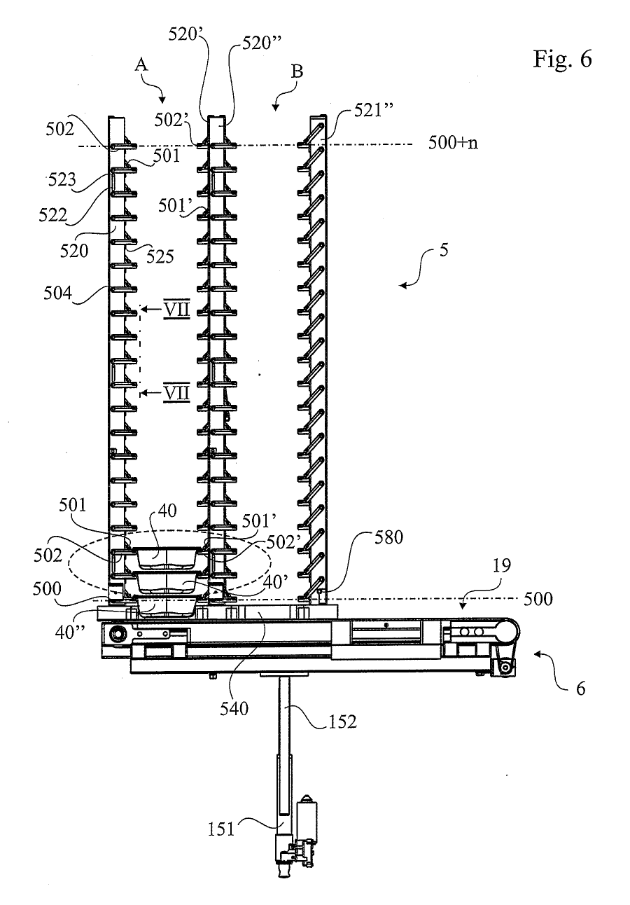

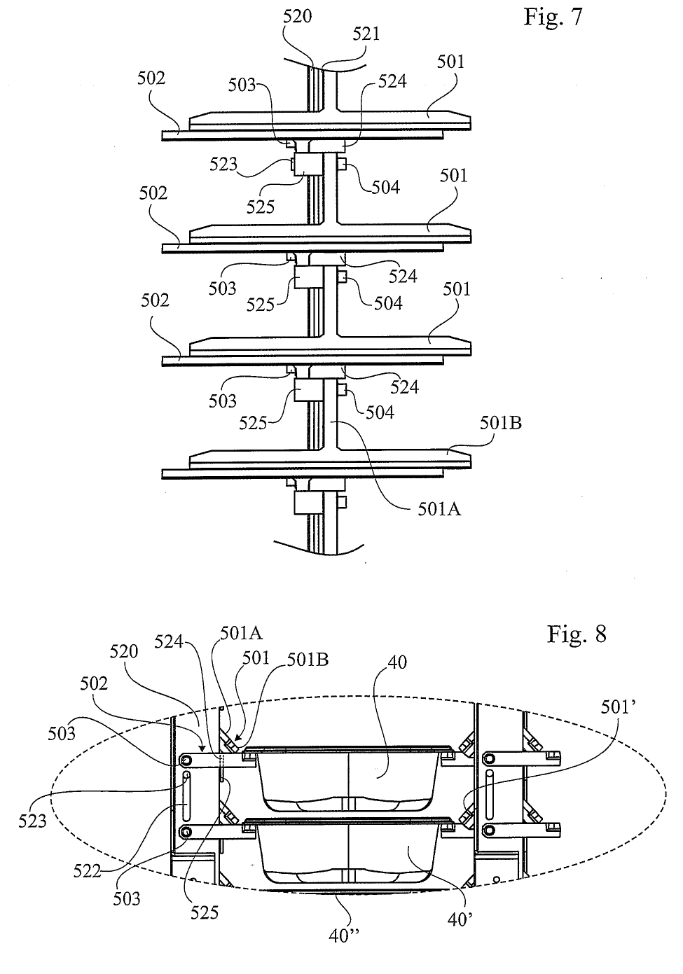

Further (see FIGS. 8 and 9) the slidable support plate 521 is provided with a first set of guide teeth 525 and the fixed support structure 520 with a second set of guide teeth 524, each tooth being equally distanced from a neighboring tooth as the distance between two, neighboring pivot pins e.g. 503. The second set of guide teeth 524 extend perpendicularly in relation to the longitudinal extension of the support structure 520 in direction towards the first pivotal arms 501 attached to the sliding guide plate 521, whereas the set of guide teeth 525 are fixedly attached to the slidable guide plate 521 and extend perpendicularly in direction towards the second pivotal arms 502. As a consequence the bottom side of the second pivotal arms 502 (attached to the fixed support structure 520) will rest on the first guide teeth 525 (fixed to the slidable support plate 521) and the first pivotal arms 501 (attached to the slidable support plate 521) will rest with the bottom side against the second guide teeth 524 (of the fixed support structure 520).

The position of the slidable support plate 521, 521′ is controlled by the position of the feed table 6, by means of having the downwardly facing ends 121A, 121′A resting in contact with the upper surface of the feed table. Accordingly the position in FIG. 6 implies that the slidable support plate 121 has been pushed upwardly by the feed table 6 to its uppermost position. This uppermost position may be controlled by the interaction of the guide pins 523 and the slit 522, but more preferred by interaction between the guiding teeth 524, 525, since as is clear from FIG. 8 these guiding pins 524, 525 will be in contact with each other in the position as shown in FIGS. 6, and 8, i.e. hindering further upward movement of the slidable support plate 521.

In the following the functioning of the design according to FIGS. 6-9 will be explained by following the consecutive steps of a package 40″ on its way to a customer. In FIG. 6 the inactivated position is shown.

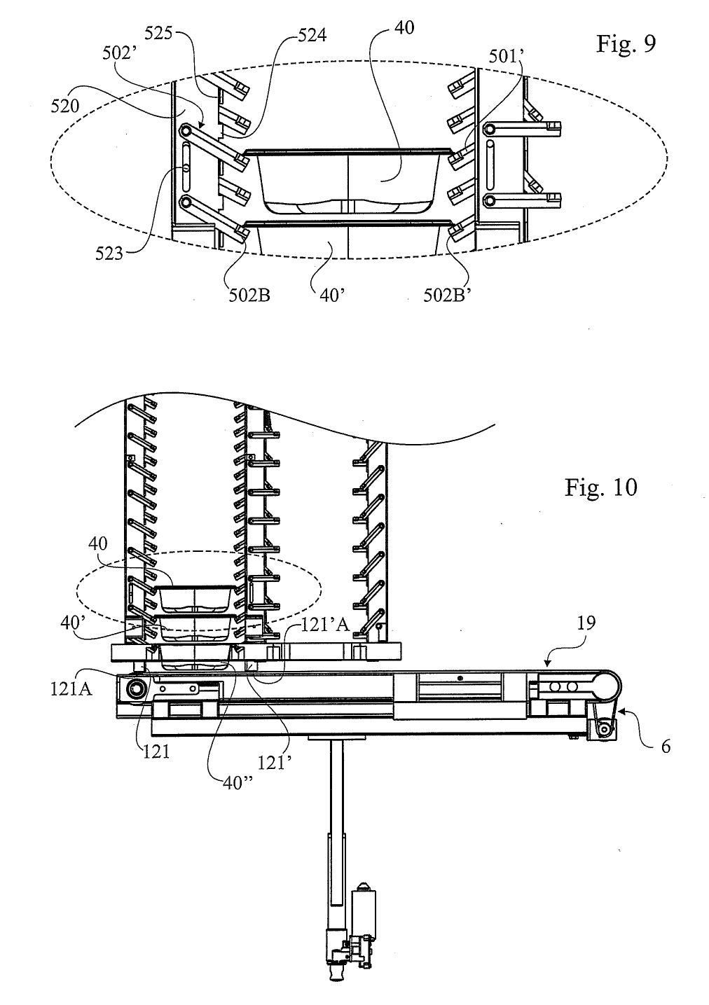

In FIG. 10 (see also FIG. 9 showing the encircled area), there is shown that the machine has been activated and accordingly the feed table 6 has moved slightly downwards. Also a solenoid (not shown) has freed the slidable guideplates 121, 121′ and as a consequence the slidable support plates 121, 121′ have moved downwards, since their ends 121A, 121′A do follow the movement of the feed table 6, whereas the guide frame 540 remains fixed. Further, due to the slidable support plate 121 have moved downwards also the first teeth 525 belonging thereto have also moved downwards, which in turn leads to the pivotal arms 502 having been moved/pivoted downward. At the same time the pivotal arms 501 have started to move upwards by interaction with the second guiding teeth 524.

The row B will not be affected due to having their solenoid, with its locking pin 580 (see FIG. 6) hindering downward movement of the sliding guideplates 521″.

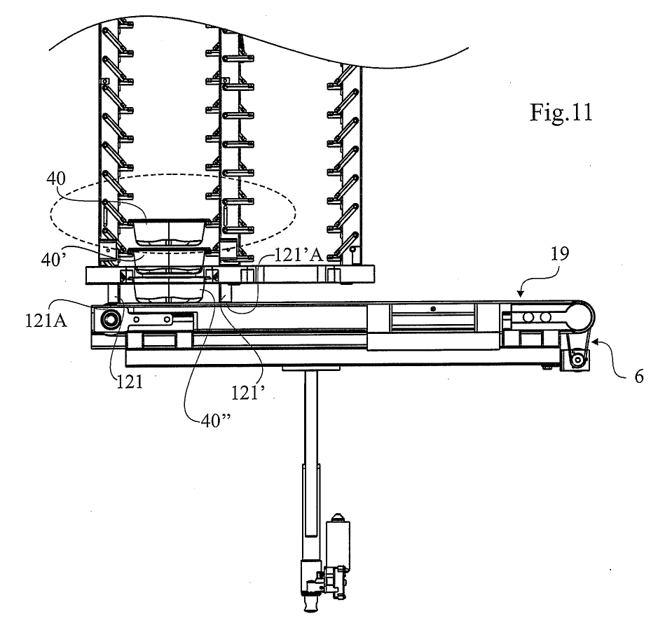

In FIG. 11 it is shown that feed table 6 has moved a sufficient distance to position the second pivotal arms 502 at a sufficient angle to open up a sufficient large distance between their ends 502B, 502B′ to let the food packages 40, 40′, 40″ pass by. At the same time the first pivoting arms 501 have moved upwards to create a more narrow passage between their ends 501B, 501′B. Accordingly each food package that has moved past the pivoting arms 502 will now land upon the holding portion 501B, B′ of the upwardly moving pivoting arms 501 As a consequence each food package 40 has moved half a level downwards in the row. Since there are no pivoting arms below the “ground level” 500 the lowermost food package 40″ will fall onto the feeding table 6.

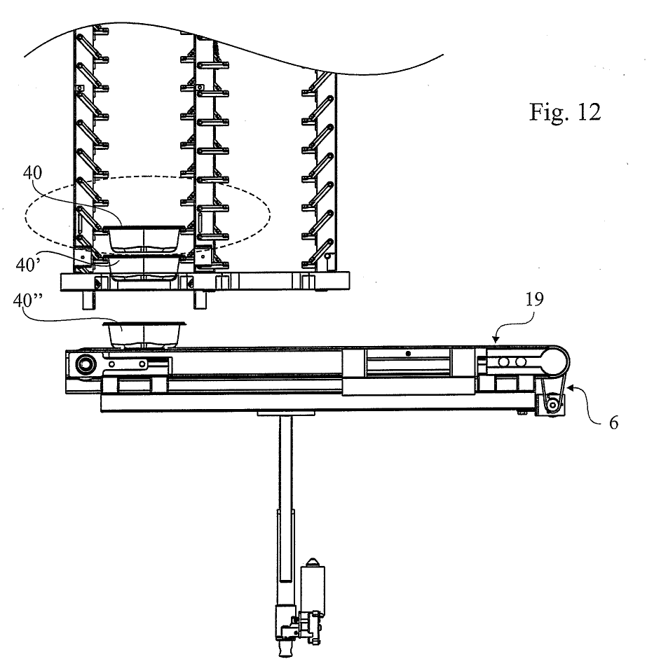

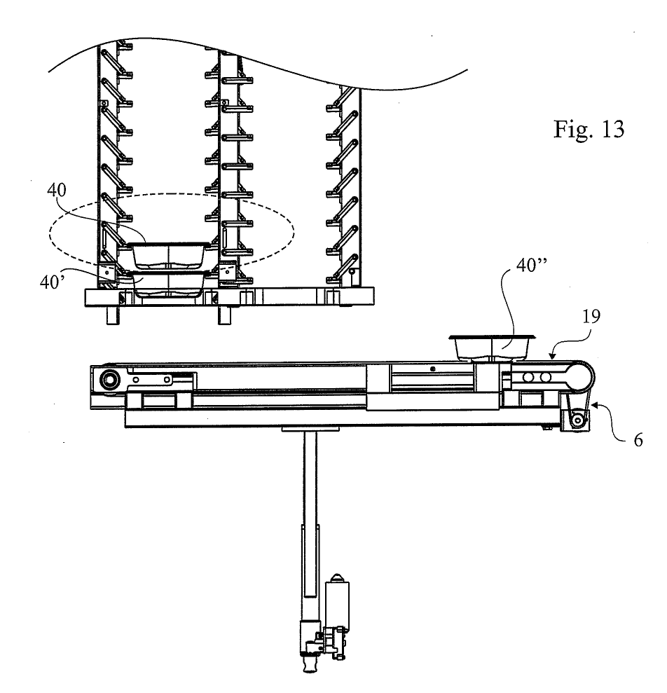

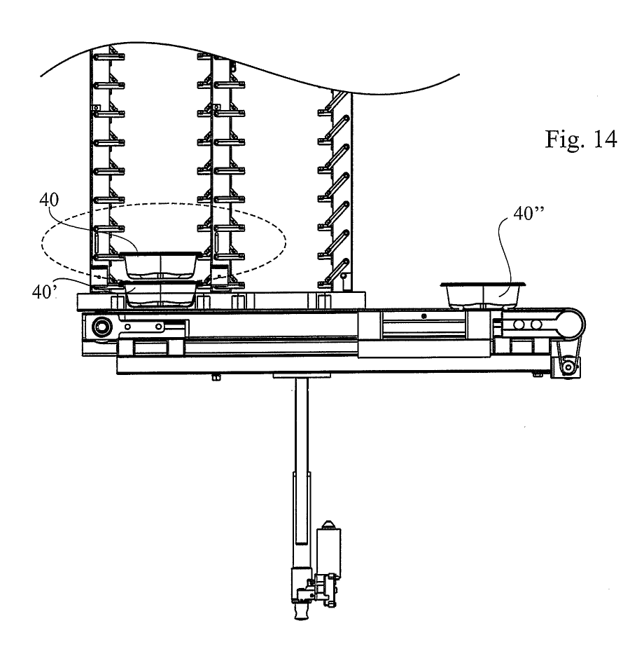

In FIG. 12 it is shown that the feeding table 6 has moved further downwards and the food package 40″ may now freely pass under the storage compartment 5. As a consequence the transport band 19 may be activated and as seen in FIG. 13 the food package 40″ will then be moved to the right-hand end of the feed table 6. At this moment the feed table 6 may again move upwards to close the storage compartment 5, i.e. to maintain the cold atmosphere therein. Simultaneously the feed table 6 will push the slidable support plates 121, 121′ upwards, whereby the food packages will be lowered the remaining ½ step of a level, as explained above. Thereafter the same kind of process will occur as has been explained above to feed and supply the package 40′ to a customer.

Thanks to the synchronised movements of the pivoting pins 501,502, in a pair-wise manner a row of food packages 40 can be stored on top of each other without contacting (or at least without putting load on) any other food package 40 in the row. Accordingly the lower most food package 40″ will then not have to carry the load of all other food packages on top of it. As a consequence the strength of the edges of a food package may be made much weaker compared to an alternative where they rest on top of each other in full contact. Hence this provides a much greater flexibility regarding choice of material for the food packages, as well as the possibility of using thinner walls and therefore also facilitating lower costs. In the preferred manner of arranging the pivoting arms, 151,152, pair wise, they are controlled in such a manner that there will be almost no free falling phase during the downward movement of a food package since they are then positioned in such a manner and provided with such a length that provides for the upwards moving pivoting arms to come into contact with a food package 40 in the interval of, slightly before, during or/and slightly after, the moment when the food package will get out of grip of the downwardly pivoting arms. It is evident for the skilled person within logistics that the principle used in the storage 5 shown in FIG. 614 can also solve similar problems within other areas than storage and supply of food packages. Indeed it may be a great advantage to use it within many different areas, where there is a need to safely feed one item at a time in combination with a need of compact and efficient storing of the items in a vertical row. Therefore it is foreseen that the principles of to efficiently store and feed of one item at a time and a structure thereof may be the subject for one or more divisional applications.

As is clear from the description above, the time during which the storage unit is open at the bottom is as short as possible in order to prevent downdraught from the same, thereby to achieve a decreased energy demand and possibly also less maintenance such as defrosting.

Naturally, the present invention can be modified within the scope of the appended claims. Accordingly, it is also possible to provide the food automate 10 with a single feed table or, as an alternative, more than two feed tables arranged abreast. As a consequence of the possible variation of feed tables, the number of microwave ovens can also be varied. It is also within the scope of the invention to split the feed table, e.g. by placing the bottom of the freezer part on sprung support units in order to enable for the bottom of the freezer part to spring up and remain in the closed position as the feed table is lowered after the heating (for dispensing) of a portion unit A solenoid or the like can then be used to keep the bottom of the freezer part fixed to the feed table in connection with the dispensing and transport from the freezer part. Moreover, it should be realised that other types of conveyors than conveyor belts can be used, such as telescopic cylinder/piston units. It is also realised that the conveyor belts can be arranged in a variety of ways in connection with the feed table in order to achieve the desired function, and hence the arrangement of grooves in the feed table is not a necessary feature as guiding/positioning of the belts can be achieved in a variety of ways. It is also possible to order a portion package on both sides at the same time, or with an overlapping time shift, i.e. to run both sides essentially at the same time in order to feed to both openings 70, 72. It should moreover be added that it is not necessary in all applications to seal or even essentially to close the bottom of the microwave oven in connection with cooking, which means that the bottom can be provided with properties that vary within wide boundaries depending on the application.

1-12. (canceled)

13. A method for automatically supplying and heating individual portions stored in a chilled or frozen condition comprising the steps of:
a) choosing an individual portion from a storage for individual portions, having cooling or freezing capacity, a vertically adjustable feed table with at least one integral conveyor being in an upper position and closing said storage for individual portions;
b) lowering the feed table and positioning said chosen individual portion thereupon; and
c) conveying the chosen individual portion to a microwave oven unit positioned beside the storage for individual portions.

14. A method according to claim 1, wherein raising the feed table such that it closes said storage for individual portions and at the same time essentially closes the microwave oven unit such that it encloses the individual portion, and heating the contents of the individual portion by activation of said microwave oven unit during a predetermined time period, and lowering the feed table again and conveying said individual portion to a dispensing position, thereafter raising the feed table again.

15. A method according to claim 1, wherein said at least one integral conveyor comprises a conveyor with conveyor belts.

16. A method according to claim 15, wherein the feed table comprises longitudinal grooves in which said conveyor belts are running.

17. A method according to claim 1, wherein said storage for individual portions have rooms that are open downwards and in that their lower edges are arranged to essentially close against the feed table.

18. A method according to claim 17, wherein the microwave oven comprises a room that opens downwards and in that the lower edges are arranged to essentially close against the feed table.

19. A method according to claim 17, wherein the lower edged seal against the feed table.

20. A method according to claim 1, wherein the dispensing position said individual portion activates a movement device that engages a dispenser cover when the feed table with the individual portion is raised to the upper position, such that the cover is brought up along with the ascending movement of the feed table and deliberates the dispenser opening, whereby said conveyor is arranged to feed forward the individual portion for manual withdrawal thereof.

21. A method according to claim 20, wherein the movement device comprises a solenoid.

22. A method according to claim 1, wherein said storage for individual portions is arranged stepwise to feed one package at the time.

23. A method according to claim 1, wherein said storage for individual portions is arranged stepwise to feed one package at the time by individual holding members for each package.

24. A food automate comprising:
a) a storage for individual portions, having cooling or freezing capacity;
b) a microwave oven unit;
c) a vertically adjustable feed table that is arranged in an upper position to close said storage for individual portions;
d) a conveyor mat arranged on said feed table; and
e) a dispenser unit for dispensing prepared individual portions.

25. A food automate according to claim 24, wherein the vertically adjustable feed table is arranged in an upper position to close said microwave.

26. A food automate according to claim 24, wherein said storage for individual portions is able to store at least two piles of individual portions, whereby an ordering device is provided for the choosing of an individual portion to drop it onto said feed table with the conveyor.

27. A food automate according to claim 26, wherein the at least two piles of individual portions hold different products.

28. A food automate according to claim 24, wherein said conveyor forms an integral part of said feed table.

29. A food automate according to claim 28, wherein said feed table is provided with longitudinal grooves in which conveyor belts run.

30. A food automate according to claims 24, wherein a movement device that is rigidly connected to said feed table is arranged to be activated such that a movable pin thereon engages a dispenser cover and is arranged to bring the cover up along with the ascending movement of the feed table and to deliberate the dispenser opening whereby said conveyor is arranged to feed forward the individual portion for manual withdrawal thereof.

31. A food automate according to claim 30, wherein the movement device comprises a solenoid.

32. A food automate according to claim 24, wherein said individual portions comprise frozen or chilled food portions.
